(19) United States
(12) Patent Application Publication
(10) Pub. No.: US 2021/0271088 A1
(43) Pub. Date: Sep. 2, 2021

(54) OPTICAL COMBINATION DEVICE AND METHOD FOR PROJECTING AN IMAGE ONTO AN EYE OF A PERSON

(71) Applicant: Robert Bosch GmbH, Stuttgart (DE)

(72) Inventor: Gael Pilard, Wankheim (DE)

(73) Assignee: Robert Bosch GmbH, Stuttgart (DE)

(21) Appl. No.: 17/265,405

(22) PCT Filed: Oct. 10, 2019
(86) PCT No.: PCT/EP2019/077435

§ 371 Date: Feb. 2, 2021

(30) Foreign Application Priority Data
Nov. 22, 2018 (DE) 10 2018 220 034.3

(51) Int. Cl. G02B 27/01; G02B 27/10; G02B 27/00

(52) U.S. Cl. CPC G02B 27/0172; G02B 2027/0123; G02B 27/0081; G02B 27/1086

(57) ABSTRACT

An optical combination device for projecting an image from an illumination device onto an eye of a person. The device includes at least two layers, which are mutually spaced apart at a distance, and spaced at different distances from the eye. Each of the layers is at least partially reflective, so that at least one reflected first sub-beam is provided by at least one of the layers by reflection off the at least one layer. The first layer, which is a shorter distance from the eye, is partially transmissive so that at least one second sub-beam is formed from an incident beam. The at least one second sub-beam is transmitted at a first angle and at least partially reflected as a reflected second sub-beam by the second layer located therebehind. The reflected first and second sub-beams each provide different positions of eyeboxes on the pupil 20 of the eye.

### FIELD

The present invention relates to an optical combination device for projecting an image onto an eye of a person.

The present invention also relates to a method for projecting an image onto an eye of a person.

Although the present invention is generally applicable to any optical combination devices, it is described with reference to head-mounted combination systems, such as eyeglasses for displaying augmented reality.

### BACKGROUND INFORMATION

Systems for displaying an augmented reality superimpose a virtual image onto a real image. In the automotive industry, for example, such systems are known as heads-up displays or, in the field of computer applications, also as “smart glasses” which, alternatively or additionally to the ambient surroundings, can be used to project an image onto the eye of a person.

A system is described in U.S. Patent Application Publication US 2015/0362734 A1 where a laser scanner system projects an image directly onto the retina through the pupil of an eye of a user. To this end, a holographic combining element is used which deflects the light onto the pupil of the user.

A heads-up display having a combination element is described in World Patent Application No. WO 2017/0117991 A1, the combination element directing the image of a display unit to an observer. For this purpose, the combination element has a plurality of holographic layers, each layer having an interference pattern. The holographic layers can be configured to be switchable, so that they can be switched on or off.

German Patent Application No. DE 10 2014 224 189 A1 also describes a heads-up display system having a combination element, the combination element being able to direct light to a viewing location. In this case, the combination element can have one or a plurality of holograms, in particular a multiplexing hologram. The holograms can be disk-shaped and disposed one behind the other in the direction of view, each hologram defining a segment having an eyebox.

### SUMMARY

In a specific example embodiment, the present invention provides an optical combination device for projecting an image from an illumination device onto an eye of a person, including at least two layers which are mutually spaced apart at a distance, and the at least two layers being spaced at different distances from the eye, each of the layers being formed to be at least partially reflective, so that at least one reflected first sub-beam is provided by at least one of the layers by reflection off of the at least one layer, and the first layer of the at least two layers, which is spaced at a shorter distance from the eye than the second of the at least two layers, being formed to be partially transmissive in such a way that at least one second sub-beam is formed from an incident beam, the at least one second sub-beam being transmitted at a first angle and at least partially reflected as a reflected second sub-beam by the second layer located therebehind, and the reflected first and second sub-beams each providing different positions of eyeboxes on the pupil of the eye.

In another specific example embodiment, the present invention provides a projection system for projecting an image onto an eye of a person, including an illumination device, in particular a laser scanner, and an optical combination device in accordance with example embodiments of the present invention.

In another specific example embodiment, the present invention provides a method for projecting an image onto an eye of a person, including the steps of
irradiating an incident beam for an image to be projected onto a first layer of at least two layers which are mutually spaced apart at a distance, and the at least two layers being spaced at different distances from the eye;
partially reflecting the incident beam off of the first layer, which is spaced at a shorter distance from the eye, in such a way that at least one reflected first sub-beam is provided;
partially transmitting the incident beam through the first layer at a first angle in such a way that at least one second sub-beam is provided;
reflecting the at least one second sub-beam off of the second layer as a reflected second sub-beam;
the reflected first and second sub-beams providing eyeboxes having different positions on the pupil of the eye.

The term “first angle” relative to the second sub-beam is understood to be the angle of the second sub-beam to the normal of a plane, here, a layer. For example, angles of incidence of the beam impinging on the layer and the first angle are equal when the incident beam is transmitted through the layer as a second sub-beam at an unchanged angle.

The term “eyebox” is understood, in particular to be that three-dimensional space within which at least one eye of a person is able to completely see a projected image. In other words, an “eyebox” is that spatial region within which a person is able to use, respectively recognize the functions of a projection system having an optical combination device.

One of the thereby attained advantages is that a plurality of eyeboxes, which are mutually spaced apart at different distances, may be readily produced on the pupil of a user, so that eye movements of the user are taken into account, because, even during eye movements, he/she sees a sharp image through the eyeboxes configured in different positions on the pupil. Moreover, it is advantageous that the eyebox resulting from the plurality of eyeboxes is larger, which makes possible higher-resolution images, at the same time with a sufficient size of the eyebox.

Other features, advantages and further specific embodiments of the present invention are described below or thereby become apparent.

In accordance with an advantageous embodiment of the present invention, the at least two layers are formed to uniformly distribute the energy of the beam, which is incident on the optical combination device, among the various reflected first and second sub-beams. This prevents different levels of brightness of the image to be projected from resulting in different eyeboxes on the pupil. Thus, in different eyeboxes, the projected image has essentially the same brightness.

In accordance with another advantageous embodiment of the present invention, the first layer is configured to form a plurality of second sub-beams, one of the further second sub-beams being transmitted with an angular deviation relative to the first angle. Here, the advantage is derived that a further eyebox offset from the eyebox of the reflected sub-beam can be readily produced on the eye by the angular deviation of the further second sub-beam resulting from a transmitted part of the incident beam.

In accordance with another advantageous embodiment of the present invention, the first layer is formed to provide the angular deviation for the at least one further sub-beam in the vertical direction. Thus, at least one further eyebox may be produced on the pupil of a user, which may be offset from the center of the pupil, for example, depending on the angular deviation in the vertical direction. A lateral offset of an eyebox is provided, in particular by suitable angles of incidence and/or distance of the second layer.

Another advantageous embodiment of the present invention provides that the further second sub-beams have an even total number. This makes possible a simple formation, respectively configuration of the layers, in particular including one or a plurality of holograms, since this makes possible, for example, a symmetrical splitting of the incident beam, in each particular case, into two further second sub-beams.

In accordance with another advantageous embodiment of the present invention, the first angle is equal to or smaller than the angle of incidence of the beam incident on the optical combination device. If the angle is equal, the beam may be very readily transmitted through the respective layer. If the first angle is formed to be smaller than the angle of incidence of the incident beam, it is transmitted further towards the perpendicular, thereby allowing a reduced thickness between the at least two layers.

In accordance with another advantageous embodiment of the present invention, the optical combination device is formed to provide an odd total number of reflected first and second sub-beams, in particular, the total number being 7, at least one of the reflected first and second sub-beams providing a position of an eyebox, which is located at the center of the pupil. One of the thereby attained advantages is that a sufficient number of eyeboxes is thereby made possible, at the same time with as few as possible layers for providing the eyeboxes. Thus, a compact optical combination device may be provided.

Another advantageous embodiment of the present invention provides that the further reflected first and second sub-beams provide positions of eyeboxes which are configured circumferentially on the edge of the pupil. Here the advantage is derived that, in response to an eye movement, even eyeboxes previously only located on the edge move into the center of the pupil, so that a sharp image is essentially always provided, even in the case of an eye movement.

Another advantageous embodiment of the present invention provides that the positions of the eyeboxes on the edge of the pupil are configured symmetrically, in particular uniformly distributed. Here the advantage is derived that a simple configuration and formation of the layers of the combination device are possible, since in the case of a uniform distribution, for example, different vertical eyeboxes on the pupil are made possible simply by symmetrically splitting the incident beam with equal angular changes relative to the angle of incidence.

Another advantageous embodiment of the present invention provides that at least one of the layers include at least one hologram and/or diffractive element. Thus, an optical function for beams incident on the optical combination device may be readily provided. The term “diffractive element” is understood, in particular to be an optical element for forming a light beam, for example, in the form of a laser beam. The diffractive element diffracts the light beam on an optical grating.

Other features and advantages of the present invention are derived from the figures, and the corresponding detailed description herein with reference to the drawings.

It is understood that the aforementioned features and those, which are still to be explained in the following, may be used not only in the particular stated combination, but also in other combinations or alone without departing from the scope of the present invention.

Preferred embodiments and specific embodiments of the present invention are illustrated in the figures and are explained in greater detail in the description below, the same reference numerals relating to the same, similar or functionally equivalent components or elements.

### BRIEF DESCRIPTION OF THE DRAWINGS

FIG. 1 is a projection system in accordance with a specific example embodiment of the present invention.

FIG. 2 is a projection system in accordance with a specific example embodiment of the present invention.

FIG. 3 is an optical combination device in accordance with a specific example embodiment of the present invention; the direction of view being along the y-axis;

FIG. 4 are parts of the optical combination device in accordance with FIG. 3, the direction of view being along the x-axis;

FIG. 5 is a configuration of eyeboxes in the plane of the pupil of a user produced by an optical combination device in accordance with a specific example embodiment of the present invention.

FIG. 6 are steps of a method in accordance with a specific example embodiment of the present invention.

### DETAILED DESCRIPTION OF EXAMPLE EMBODIMENTS

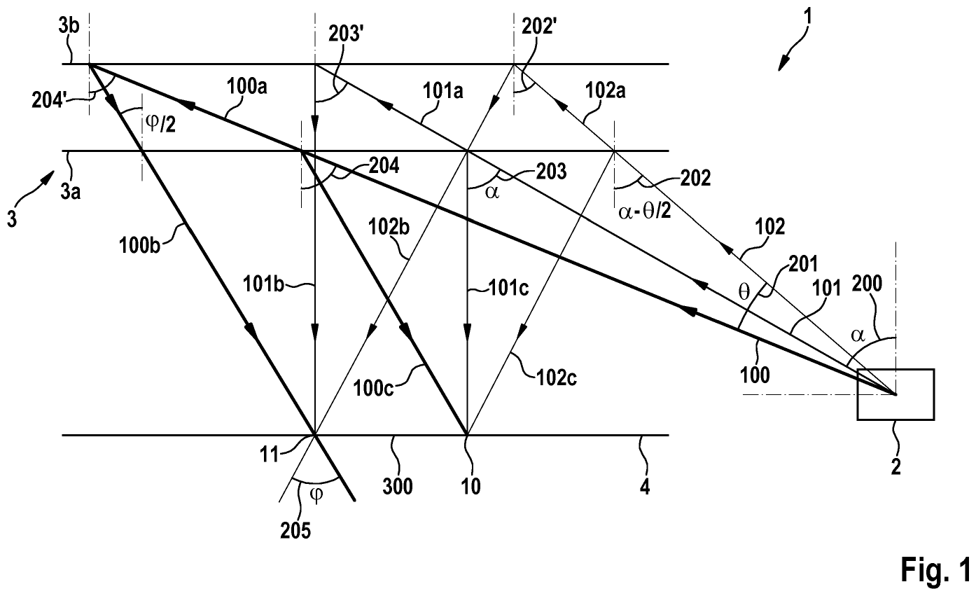

FIG. 1 schematically shows a projection system in accordance with a specific example embodiment of the present invention.

FIG. 1 shows a projection system 1. Projection system 1 includes a laser scanning system 2 which irradiates an optical combination device 3 with light. FIG. 1 exemplarily shows beams 100, 101, 102 which impinge at different angles on an optical combination device 3. Optical combination device 3 includes two layers 3a, 3b here, which, in the viewing direction, are configured at different distances from an eye 4 of a person.

In detail, laser scanning system 2 transmits light beams 100, 101, 102 of at least one wavelength at different angles in the direction of optical combination device 3. Here in FIG. 1, light beam 101 features an angle α—reference numeral 200—relative to a vertical. Beams 100, 102 are thereby offset upwards, respectively downwards by angle θ/2—reference numeral 201 for angle θ—relative to central beam 101.

The path of beams 100, 101, 102 is described at this stage in the following. Beam 101, which is emitted by laser scanning system 2, first impinges on first layer 3a of optical combination device 3 and is partially reflected there at angle 203, which corresponds to angle 200, partially reflected —reflected beam 101c—, so that this beam 101c impinges perpendicularly onto eye 4 at a specific position 10. However, first layer 3a is formed to not only be reflective, but also transmissive. Thus, first layer 3a transmits a part of incident beam 101—transmitted beam 101a-therethrough. In the further course, this beam 101a impinges on second layer 3b of optical combination device 3. There, beam 101a is fully reflected by second layer 3b at angle 203′, which is the same size as angle 200, and impinges perpendicularly on eye 4 at a further position 11. Since layers 3a, 3b feature a distance therebetween, the two positions 10, 11 are likewise spaced apart at a lateral distance 300.

The path of the two further light beams 100, 102 is analogous, as are corresponding angles 202, 202′, 204, 204′. Accordingly, these light beams 100, 102 are partially reflected (reflected beams 100c, 102c) by first layer 3a, for one thing, and are likewise transmitted further (beam 100a, 102a) by first layer 3a in the direction of second layer 3b. These are then reflected (beam 100b, 102b) off of second layer 3b in such a way that reflected beams 100b, 102b impinge at position 11 and beams 100c, 102c at position 10. As do other angles 202′ and 204′, angle 203′ corresponds to a “first angle” since angles 202, 202′, 203, 203′ and 204, 204′ each form corresponding angles at the two parallel layers 3a, 3b. Beams 100b, 102b, respectively 100c, 102c thereby form an angle 205 therebetween at the respective position on eye 4, which forms the field of view. This is essentially determined by the scanning angle of the retina through the pupil and depends, in particular on the position of laser scanning system 2 relative to optical combination device 3. Here, a “crosstalk” at different layers 3a, 3b, thus multiple reflection, may be prevented by the field of view being limited accordingly:

$$\frac{φ}{2} < - \frac{θ}{2}$$

Thus, in the case of an angle 200 of 60° and an angle 201 of 30°, field of view 205 is limited to 90°. Another possible possibility is that first layer 3a be formed to provide a reflection angle as a function of the position of the point of incidence of the beam emitted by laser scanning system 2. For example, beam 102 having an angle of incidence of

$$α + \frac{Θ}{2}$$

on first layer 3a may “see” a different optical function than the beam having angle of incidence 200 and beam 100 having angle of incidence

$$α + \frac{Θ}{2} .$$

The optical function provided by optical combination device 3 thus has different properties for different positions on the surface thereof.

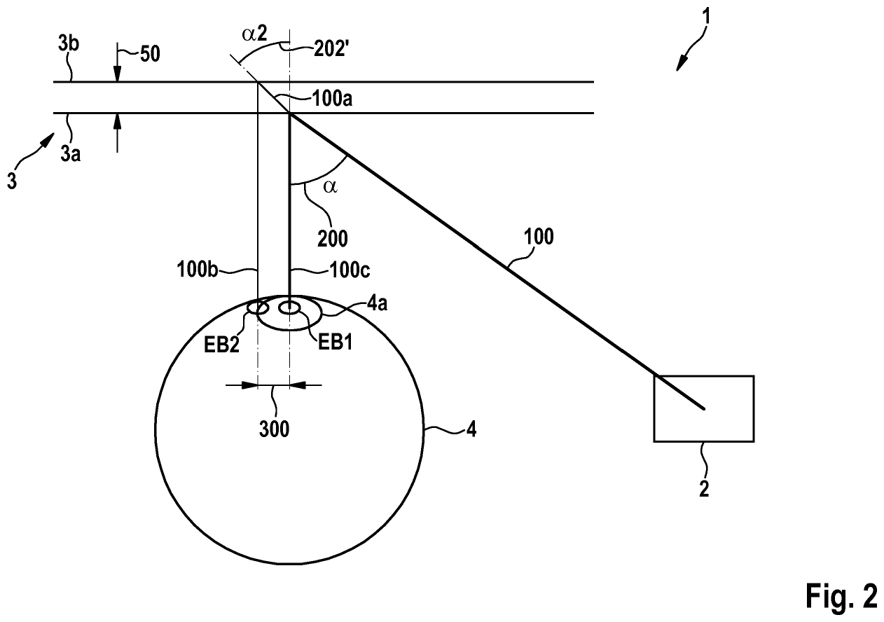

FIG. 2 schematically shows a projection system in accordance with a specific embodiment of the present invention.

FIG. 2 essentially shows a simplified view of projection system 1 in accordance with FIG. 1. In contrast to FIG. 1, FIG. 2 shows merely one beam 100 here, which is emitted by laser scanning system 2 and impinges at an angle α—reference numeral 200—on first layer 3a. Here, it is reflected —reflected beam 100c—and generates an eyebox EB1 in the center of pupil 4a of eye 4. Beam 100 of laser scanning system 2 that is incident on first layer 3a is likewise transmitted —beam 100a—, but not simply further at angle of incidence a 200, but at an angle α₂, reference numeral 202′, which thus forms the “first angle.” Beam 100a transmitted in this manner then impinges on second layer 3b, which reflects transmitted beam 100a in such a way that it generates, respectively provides a second eyebox EB2 on the edge of pupil 4a. The distance between the two layers 3a, 3b and distance 300 of the two eye boxes EB1, EB2 on pupil 4a may be determined as follows:

$$d 1 = \frac{δ x}{tan [ arcsin ( \frac{sin ( α )}{{n}_{2}} ) ]}$$

Assuming that the pupil has a diameter of 3.5 mm and angle α—reference numeral 200—60° and the distance between the two eyeboxes EB1, EB2 is 1.75 mm, and a material having a refractive index n₂=1.5 is configured between the two layers 3a, 3b, a thickness dl of 2.475 mm is obtained.

If, at this stage, the angle of incidence—“first angle”—on second layer 3b is increased in accordance with the above explanations, for example, to 65°, the thickness may be reduced in accordance with

$$d 1 = \frac{δ x}{tan ( {α}_{2} )} = 0.816 mm$$

for example, to the specified 0.816 mm, which reduces the installation space of optical combination device 3.

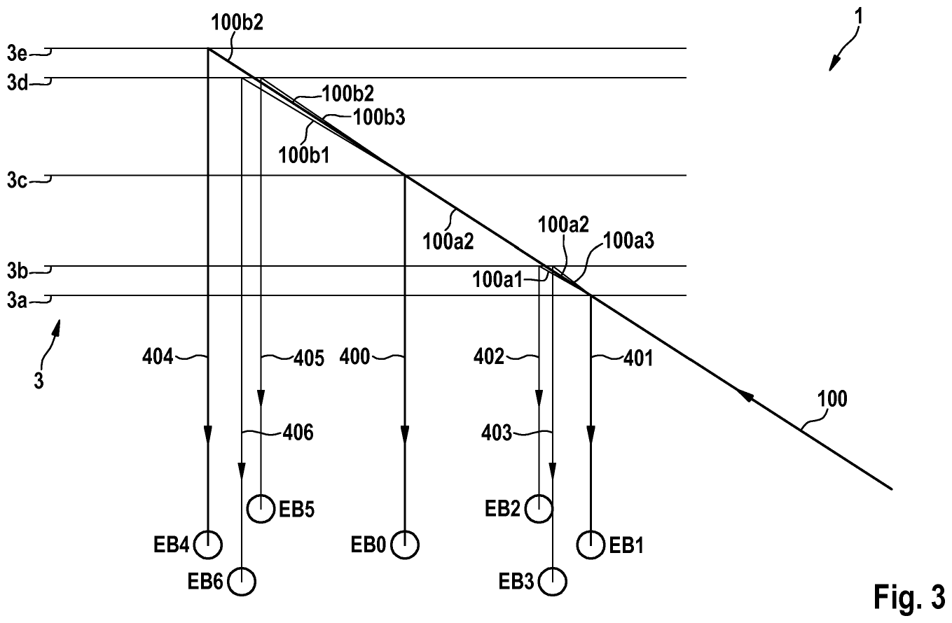

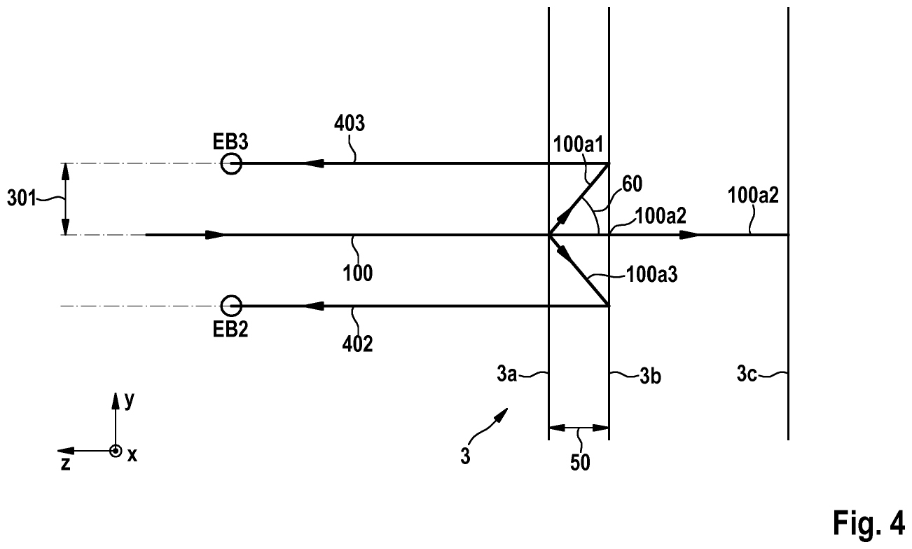

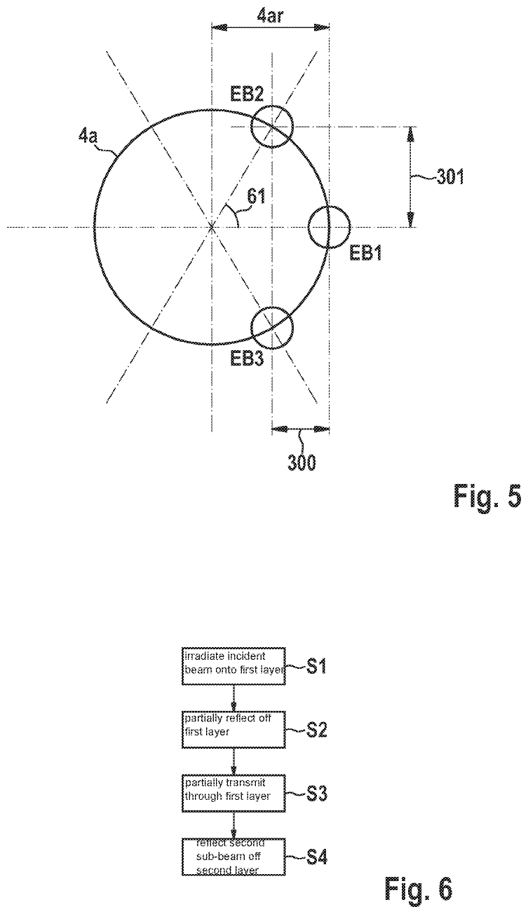

FIG. 3 schematically shows an optical combination device in accordance with a specific embodiment of the present invention, the direction of view being along the y-axis; FIG. 4 shows parts of the optical combination device in accordance with FIG. 3, the direction of view being along the x-axis; and FIG. 5 a configuration of eyeboxes in the plane of the pupil of a user produced by an optical combination device in accordance with a specific embodiment of the present invention.

FIG. 3 shows an optical combination device 3, which has altogether five layers 3a, 3b, 3c, 3d, 3e, which are disposed one behind the other and mutually in parallel. Also shown is an incident beam 100 of a laser scanning system (not depicted here). Incident beam 100 is reflected off of first layer 3a-reflected beam 401—and forms, respectively provides a first eyebox EB1 on a pupil (not shown here) of a person. In addition, first layer 3a transmits incident beam 100 in such a way that it produces three sub-beams 100a1, 100a2, 100a3: one 100a2 of the three sub-beams 100a1, 100a2, 100a3 is transmitted without an angular change and two sub-beams 100a1, 100a3 with a different vertical orientation in the direction of second layer 3b.

Thus, in the further course thereof, the three sub-beams 100a1, 100a2, 100a3 transmitted by first layer 3a impinge on second layer 3b. In this case, middle 100a2 of the three incident beams 100a1, 100a2, 100a3 is transmitted further without an angular change; the two further beams 100a1, 100a3 having the respective vertical deviation are reflected by second layer 3b-reflected beams 402, 403—and form, respectively provide a second and a third eyebox EB2, EB3.

As explained above, middle 100a2 of the three beams 100a1, 100a2, 100a3 is transmitted further and, for one thing, is reflected by third layer 3c-reflected beam 400—and thereby forms, respectively provides a further eyebox EBO. Analogously to first layer 3a, third layer 3c generates three transmitted beams 100b1, 100b2, 100b3; of these, two 100b1, 100b3 of beams 100b1, 100b2, 100b3 having a different vertical orientation. These three beams 100b1, 100b2, 100b3 impinge at this stage on fourth layer 3d, which functions analogously to second layer 3b: middle beam 100b2 is transmitted further in the direction of fifth layer 3e with an unchanged vertical deviation. The two other beams 100b1, 100b3, thus the beams having different vertical orientations, are reflected by fourth layer 3d-reflected beams 405, 406—and produce, respectively provide further eyeboxes EB5, EB6.

Beam 100b2 transmitted through layer 3d finally impinges on fifth layer 3e and is reflected by the same—reflected beam 404—and provides a further eyebox EB4.

At this stage, FIG. 4 shows in detail the vertical beam splitting at first layer 3a. Here, distance 50 between the two layers 3a, 3b is formed in such a way that a desired vertical distance 301 of eyeboxes EB2, EB3 is provided accordingly. In other words, incident beam 100 at first layer 3a is split into a further transmitted beam 100a2 in the direction of second layer 3b and two further sub-beams 100a1, 100a3, which are each deflected at an angle 60 from the direction of transmitted beam 100a2. These two sub-beams 100a1, 100a3 are reflected by second layer 3b, reflected beams 402, 403, and produce the two eyeboxes EB2, EB3. The respective distances 300 in the lateral direction, respectively 301 in the vertical direction may thereby be computed, respectively adjusted as follows: Assuming a pupil diameter of 3.5 mm and a corresponding radius Oar of 1.75 mm, along with eyeboxes EB1, EB2, EB3 on the edge of pupil 4a offset in each case by 60°—angle 61—to the pupil center, a lateral deviation of 0.875 mm (reference numeral 300) and a vertical deviation of 1.516 mm (reference numeral 301) are obtained. Thickness 50 between the two layers 3a, 3b may thereby be computed on the basis of lateral deviation 300 and the corresponding angle of incidence: Assuming, for example, an angle of incidence of 65° on second layer 3b for this, a thickness 50 of 0.505 mm is thus obtained. The beam angle, which must be provided by sub-beams 100a1, 100a3 with a vertical deviation—reference numeral 60—may be computed in accordance with the following formula:

$$ω = arctan ( \frac{δ y}{{d}_{23}} ) = 71.5 {8}^{∘}$$

Laser scanning system 2 is thereby configured in such a way that angle 60 is large enough relative to the vertical scanning amplitude to avoid a crosstalk. For example, if Ω denotes the vertical scanning amplitude, angle 60 must be greater than ω-Ω/2>Ω/2.

FIG. 6 shows steps of a method in accordance with a specific example embodiment of the present invention.

FIG. 6 schematically shows steps of a method for projecting an image onto an eye of a person. The method thereby includes the following steps.

In a first step S1, an incident beam for an image to be projected is irradiated onto a first layer of at least two layers, which are mutually spaced apart at a distance, and the at least two layers featuring different distances from the eye.

In another step S2, the incident beam is partially reflected off of the first layer, which is spaced at a shorter distance from the eye in such a way that at least one reflected first sub-beam is provided.

In another step S3, the incident beam is partially transmitted through the first layer at a first angle in such a way that at least one second sub-beam is provided.

In another step S4, the at least one second sub-beam is reflected off of the second layer as a reflected second sub-beam.

The reflected first and second sub-beams thereby provide eyeboxes having different positions on the pupil of the eye.

In summary, at least one of the specific embodiments of the present invention has at least one of the following advantages:

simple design;

cost-effective manufacturing;

reliable imaging;

large field of view;

wide variety of fields of application, in particular for smart glasses.

Although the present invention has been described with reference to preferred exemplary embodiments, it is not limited thereto, but may be modified in numerous ways.

1-12. (canceled)

13. An optical combination device for projecting an image from an illumination device onto an eye of a person, comprising:
at least two layers, which are mutually spaced apart at a distance, and the at least two layers having different distances from the eye relative to one another, each of the layers is at least partially reflective, so that at least one reflected first sub-beam is provided by at least one of the layers by reflection off the at least one layer;
wherein a first layer of the at least two layers, which is spaced at a shorter distance from the eye than a second layer of the at least two layers, is partially transmissive, in such a way that at least one second sub-beam is formed from an incident beam, the at least one second sub-beam being transmitted at a first angle and at least partially reflected as a reflected second sub-beam by the second layer located behind the first layer, and the reflected first and second sub-beams each providing different positions of eyeboxes on a pupil of the eye, relative to one another.

14. The optical combination device as recited in claim 13, wherein the at least two layers uniformly distribute energy of the beam, which is incident on the optical combination device, among the reflected first and second sub-beams.

15. The optical combination device as recited in claim 13, wherein the first layer is configured to form a plurality of second sub-beams including the at least one second sub-beam, at least one further one of the second sub-beams other than the at least one second sub-beam being transmitted with an angular deviation relative to the first angle.

16. The optical combination device as recited in claim 15, wherein the first is formed to provide the angular deviation for the at least one further second sub-beam in a vertical direction.

17. The optical combination device as recited in claim 15, wherein the at least one further second sub-beam has an even total number.

18. The optical combination device as recited in claim 13, wherein the first angle is equal to or smaller than an angle of incidence of the beam which is incident to the optical combination device.

19. The optical combination device as recited in claim 13, wherein the optical combination device is formed to provide an odd total number of reflected first and second sub-beams, the total number being 7, at least one of the reflected first and second sub-beams providing a position of an eyebox that is located at the center of the pupil.

20. The optical combination device as recited in claim 19, wherein further ones of the reflected first and second sub-beams provide positions of eyeboxes, which are circumferentially disposed on an edge of the pupil.

21. The optical combination device as recited in claim 20, the positions of the eyeboxes are configured symmetrically, uniformly distributed, on the edge of the pupil.

22. The optical combination device as recited as recited in claim 13, where at least one of the layers includes at least one hologram and/or a diffractive element.

23. A projection system for projecting an image onto an eye of a person, comprising:
a laser scanner; and
an optical combination device for projecting an image from the laser scanner onto an eye of a person, including:
at least two layers, which are mutually spaced apart at a distance, and the at least two layers having different distances from the eye relative to one another, each of the layers is at least partially reflective, so that at least one reflected first sub-beam is provided by at least one of the layers by reflection off the at least one layer;
wherein a first layer of the at least two layers, which is spaced at a shorter distance from the eye than a second layer of the at least two layers, is partially transmissive, in such a way that at least one second sub-beam is formed from an incident beam, the at least one second sub-beam being transmitted at a first angle and at least partially reflected as a reflected second sub-beam by the second layer located behind the first layer, and the reflected first and second sub-beams each providing different positions of eyeboxes on a pupil of the eye, relative to one another.

24. A method for projecting an image onto an eye of a person, comprising the following steps:
irradiating an incident beam for an image to be projected onto a first layer of at least two layers, which are mutually spaced at a distance, and the at least two layers being spaced at different distances from the eye relative to one another;
partially reflecting the incident beam off a first layer, which is spaced at a shorter distance from the eye relative to a second layer of the at least two layers in such a way that at least one reflected first sub-beam is provided;
partially transmitting the incident beam through the first layer at a first angle in such a way that at least one second sub-beam is provided; and
reflecting the at least one second sub-beam off the second layer as a reflected second sub-beam;
wherein the reflected first and second sub-beams providing eyeboxes different positions on the pupil of the eye, relative to one another.
